(19) United States
(12) Patent Application Publication
(10) Pub. No.: US 2010/0057382 A1
(43) Pub. Date: Mar. 4, 2010

(54) WATER RESOURCE MONITORING SYSTEM AND METHOD

(75) Inventor: CHENG-HSIU LI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/503,658

(22) Filed: Jul. 15, 2009

(30) Foreign Application Priority Data
Aug. 27, 2008 (CN) 200810304220.8

(51) Int. Cl. G01F 1/34

(52) U.S. Cl. 702/47

(57) ABSTRACT

A method for monitoring measurement of water resources controls a measurement meter to acquire and report measurement data of the water resource to a monitoring server through sending short messages comprising control commands. The method also presets a reporting period for the measurement meter to automatically acquire and report the measurement data to the monitoring server.

### BACKGROUND

1. Technical Field

Embodiments of the present disclosure generally relate to monitoring, and more particularly to a system and method for monitoring water resources remotely.

2. Description of Related Art

Nowadays, most resources are monitored and controlled by manpower. For example, measurements of water quantity and pressure, shutoff of valves, and measurements and controls of electrical powers for reservoirs, river, lake, and water tower, are monitored by workers.

However, manually monitoring water resources is very time-consuming and inefficient.

### BRIEF DESCRIPTION OF THE DRAWINGS

FIG. 1 is a block diagram of one embodiment of a water resource monitoring system;

FIG. 2 is a block diagram of one embodiment of function modules of a measurement system in the water resource monitoring system; and

FIG. 3 is a flowchart illustrating one embodiment of a method for monitoring water resource.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, a word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described hereinafter may be implemented as either software and/or hardware modules and may be stored in any type of computer-readable medium or other computer storage device.

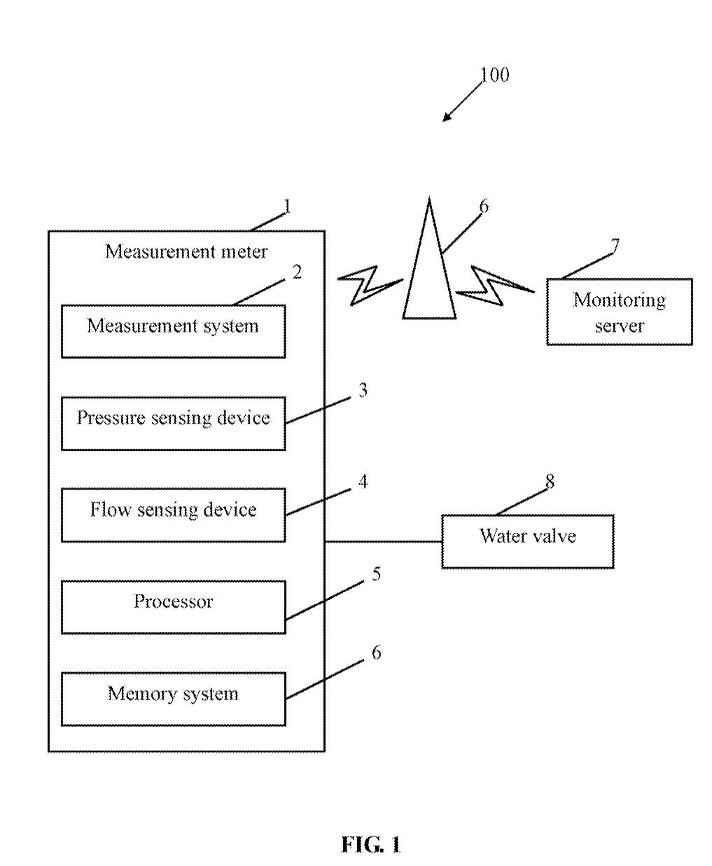

FIG. 1 is a block diagram of one embodiment of a water resource monitoring system 100. The monitoring system 100 can monitor measurement of water resources, such as in a lake, or a river, for example. In one embodiment, the monitoring system 100 includes a measurement meter 1, a water valve 8, and a monitoring server 7. The water valve 8 is connected to the measurement meter 1, and regulates water flow of the water resource by opening, closing, or partially obstructing various passageways. The monitoring server 7 communicates with the measurement meter 1 via a base station 6.

In one embodiment, the monitoring server 7 sends control commands to the measurement meter 1 and receives measurement data of the water resource from the measurement meter 1 using short messages via the station 6. In one embodiment, the control commands may include, but are not limited to, commands of opening/closing the water valve 8, acquiring the measurement data, and reporting the measurement data to the monitoring server 7, for example. The measurement data may include, but are not limited to, water pressure and water flow of the water resource, for example.

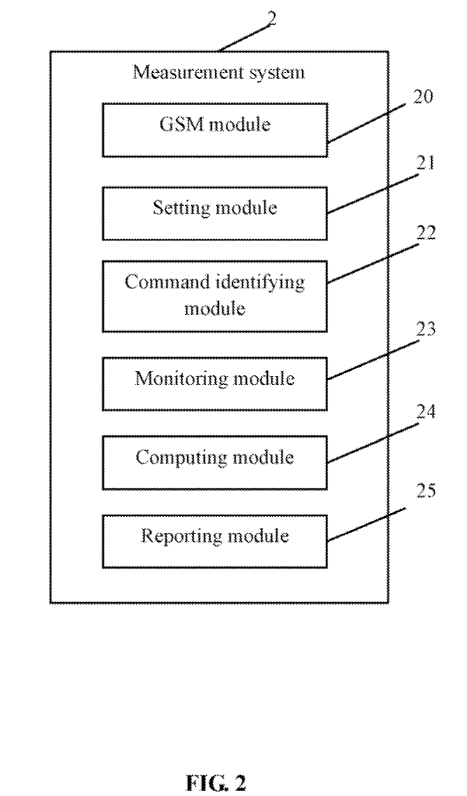

In one embodiment, the measurement meter 1 includes a measurement system 2, a pressure sensing device 3, and a flow sensing device 4. The measurement system 2 can be used to execute the control commands from the monitoring server 7 to open/close the water valve 8 and acquire the measurement data, for example. In one embodiment, the measurement system 2 may include function modules, such as a global system for mobile communication (GSM) module 20, a setting module 21, a command identifying module 22, a monitoring module 23, a computing module 24, and a reporting module 25 (refer to FIG. 2). The pressure sensing device 3 can measure the water pressure of the water resource, and the flow sensing device 4 can measure the water flow of the water resource.

The measurement meter 1 also includes at least one processor 5 and a memory system 6. The processor 5 is for computing and executing the function modules 20-25 of the measurement system 2. The memory system 6 may be, such as a random access memory (RAM) for temporary storage of information, such as the measurement data, and/or a read only memory (ROM) for permanent storage of the information.

FIG. 2 is a block diagram of one embodiment of the function modules 20-25 of the measurement system 2. The function modules 20-25 may be used to implement certain systems and methods for the measurement meter 1 described herein to monitor measurement of the water resource.

The GSM module 20 can receive and send short messages between the monitoring server 7 and the measurement system 2 via the station 6.

The setting module 21 is operable to preset command short messages. The command short message can be identified by the monitoring server 7 and the measurement system 2. The command short messages include the control commands, such as commands of opening/closing the water valve 8, acquiring the measurement data, and reporting the measurement data to the monitoring server 7, for example.

The setting module 21 is further operable to preset a reporting period for the measurement system 2 to automatically report the measurement data of the water resource to the monitoring server 7. The reporting period specifies a time when the measurement system 2 should acquire and send the measurement data to the monitoring server 7 automatically. For example, if the reporting period is two days, the measurement system 2 automatically acquires and sends the measurement data to the monitoring server 7 every two days.

The command identifying module 22 is operable to identify a short message received by the GSM module 20. The command identifying module 22 determine whether the received short message is one of the command short messages. If the received short message is one of the command short messages, the command identifying module 22 sends the received short message to the monitoring module 23.

The monitoring module 23 is operable to execute the control commands included in the received short messages to open/close the water valve 8, acquire the measurement data, and report the measurement data to the monitoring server 7, for example.

The monitoring module 23 is further operable to automatically acquire the measurement data according to the preset reporting period, such as acquiring the water pressure from the pressure sensing device 3 and acquiring the water flow from the flow sensing device 4 when the preset reporting period arrives. The monitoring module 23 further stores the measurement data and other related measurement data into the memory system 6. The other related measurement data includes, such as the time of acquiring the measurement data.

The computing module 24 is operable to process the measurement data. As mentioned above, the memory system 6 stores the measurement data and the time of acquiring the measurement data. Thus, the computing module 24 can compute water flow in a certain duration according to the measurement data and the time of acquiring the measurement data.

The reporting module 25 is operable to edit the measurement data or the processed measurement data into a reporting short messages, and to send the reporting short messages to the monitoring server 7. It may be understood that, the reporting short message can be sent by the GSM module 20 via the station 6 and be identified by the monitoring server 7.

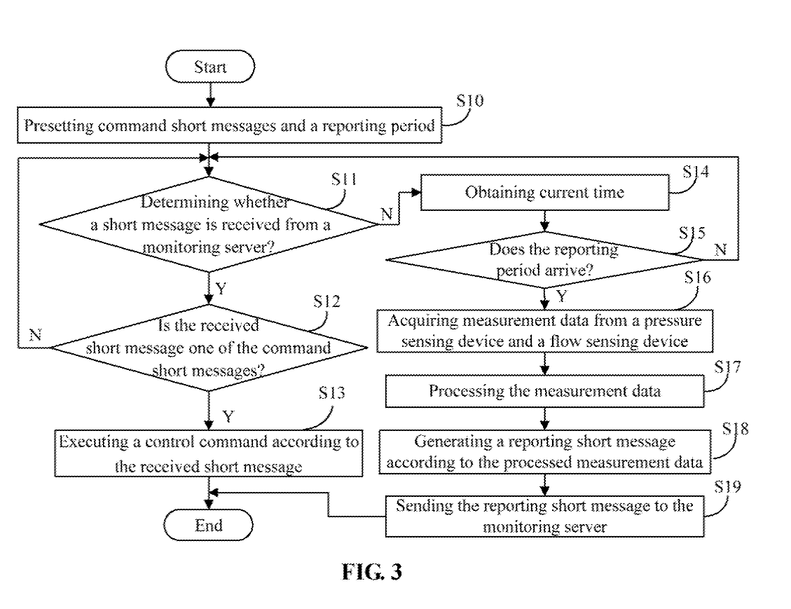

FIG. 3 is a flowchart illustrating one embodiment of a method for monitoring water resource. Depending on the embodiment, additional blocks in the flow of FIG. 3 may be added, others removed, and the ordering of the blocks may be changed.

In block S10, the setting module 21 presets a plurality pieces of command short messages and a reporting period. The command short messages can be identified by the monitoring server 7 and the measurement system 2. As mentioned above, the command short messages include the control commands, such as commands of opening/closing the water valve 8, acquiring the measurement data, and reporting the measurement data to the monitoring server 7, for example. The reporting period specifies a time for automatically reporting the measurement data of the water resource to the monitoring server 7.

In block S11, the command identifying module 22 determines whether at least one short message is received by the GSM module 20 from the monitoring server 7. The flow goes to block S14 if no short message is received. Otherwise, the flow goes to block S12 if at least one short message is received by the GSM module 20 from the monitoring server 7.

In block S12, the command identifying module 22 determines whether the received short message is one of the command short messages. If the received short message is one of the command short messages, the flow goes to block S13 described below. Otherwise, if the received short message is not one of the preset command short messages, the flow returns to block S11 described above.

In block S13, the monitoring module 23 executes a control command included in the received short message.

In block S11, if the command identifying module 22 determines that no short message is received by the GSM module 20 from the monitoring server 7, then, in block S14, the GSM module 20 obtains current time.

In block S15, the computing module 24 determines whether the reporting period arrives according to the current time. If the reporting period arrives, the flow goes to block S16 described below. Otherwise, if the reporting period does not arrive, the flow returns to block S11 descried above.

In block S16, the monitoring module 23 acquires measurement data from the pressure sensing device 3 and the flow sensing device 4, and stores the measurement data and other related measurement data into the memory system 6. The measurement data may include the water pressure and the water flow of the water resource, and the other related measurement data may be, such as time of acquiring the measurement data.

In block S17, the computing module 24 processes the measurement data using the time of acquiring the measurement data. For example, the computing module 24 computes water flow in certain duration according to the measurement data and the time of acquiring the measurement data.

In block S18, the reporting module 25 generates a reporting short message according to the measurement data or the processed measurement data. The reporting short message can be sent by the GSM module 20 and identified by the monitoring server 7.

In block S19, the reporting module 25 sends the reporting short message to the monitoring server 7.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A water resource monitoring method using a measurement meter comprising a global system for mobile communication (GSM) module, the measurement meter in communication with a water valve and a monitoring server of a water resource, the method comprising:
(a) presetting command short messages comprising control commands for opening/closing of the water valve, acquiring measurement data of the water resource, and reporting the measurement data to the monitoring server, and presetting a reporting period specifying a time for acquiring and sending the measurement data of the water resource to the monitoring server automatically;
(b) receiving at least one short message by the GSM module;
(c) determining whether the received short message is one of the command short messages; and
(d) executing a control command according to the received short message to open/close the water valve, acquire measurement data of the water resource, and/or report the measurement data to the monitoring server upon the condition that the received short message is one of the preset command short messages.

2. The method as described in claim 1, wherein the measurement data comprises water pressure and water flow of the water resource.

3. The method as described in claim 1, further comprising:
obtaining current time upon the condition that no short message is received by the GSM module;
determining whether the reporting period arrives according to the current time;
acquiring the measurement data automatically when the reporting period arrives;
storing the measurement data and time of acquiring the measurement data into a memory system of the measurement meter.

4. The method as described in claim 3, further comprising:
processing the measurement data using the time of acquiring the measurement data.

5. The method as described in claim 4, further comprising:
generating a reporting short message according to the measurement data; and
sending the reporting short message to the monitoring server.

6. A storage medium having stored thereon instructions that, when executed by a processor, causing the processor to perform a method for monitoring measurement of water resource using a measurement meter, the method comprising:
(a) presetting command short messages comprising control commands for opening/closing of the water valve, acquiring measurement data of the water resource, and reporting the measurement data to the monitoring server, and presetting a reporting period specifying a time for acquiring and sending the measurement data of the water resource to the monitoring server automatically;
(b) receiving at least one short message by a GSM module;
(c) determining whether the received short message is one of the command short messages; and
(d) executing a control command according to the received short message to open/close the water valve, acquire measurement data of the water resource, and/or report the measurement data to the monitoring server upon the condition that the received short message is one of the preset command short messages.

7. The storage medium as described in claim 6, wherein the measurement data comprises water pressure and water flow of the water resource.

8. The storage medium as described in claim 6, further comprising:
obtaining current time upon the condition that no short message is received by the GSM module;
determining whether the reporting period arrives according to the current time;
acquiring the measurement data automatically when the reporting period arrives;
storing the measurement data and time of acquiring the measurement data into a memory system of the measurement meter.

9. The storage medium as described in claim 8, wherein the method further comprises:
processing the measurement data using the time of acquiring the measurement data.

10. The storage medium as described in claim 9, wherein the method further comprises:
generating a reporting short message according to the measurement data; and
sending the reporting short message to the monitoring server.

11. A system for monitoring measurement of water resource using a measurement meter, wherein the measurement meter in communication with a water valve and a monitoring server, the system comprising:
a setting module operable to preset command short messages comprising control commands for opening/closing of the water valve, acquiring measurement data of the water resource, and reporting the measurement data to the monitoring server, and presetting a reporting period specifying a time for acquiring and sending the measurement data of the water resource to the monitoring server automatically;
a global system for mobile communication (GSM) module operable to receive a short message from the monitoring server;
a command identifying module operable to determine whether the short message received by the GSM module is one of the preset command short messages;
a monitoring module operable to execute control commands according to the received short message upon the condition that the received short message is one of the preset command short messages; and
a processor that executes the setting module, the command identifying module, and the monitoring module.

12. The system as described in claim 11, wherein the measurement data comprises water pressure and water flow of the water resource.

13. The system as described in claim 15, wherein the monitoring module is further operable to automatically acquire the measurement data when the reporting period arrive, and store the measurement data and time of acquiring the measurement data into a memory system.

14. The system as described in claim 13, further comprising:
a computing module operable to process the measurement data using the time of acquiring the measurement data.

15. The system as described in claim 11, further comprising:
a reporting module operable to generate a reporting short message according to the measurement data, and send the reporting short message to the monitoring server.
